(19) United States
(12) Patent Application Publication
(10) Pub. No.: US 2005/0179255 A1
(43) Pub. Date: Aug. 18, 2005

(54) Windowed postcard mailer

(76) Inventor: James L. Olson, Chanhassen, MN (US)

Correspondence Address: WARD KRAFT, INC., P.O. BOX 938, FORT SCOTT, KS, 66701, US

(21) Appl. No.: 10/781,070

(22) Filed: Feb. 18, 2004

(51) Int. Cl. B42D 15/00

(52) U.S. Cl. 283/105

(57) ABSTRACT

A windowed postcard mailer intermediate is provided so that the mailer can be processed by simplex printing, printing only on a single side. The windowed mailer intermediate of the present invention is printed with customer interaction indicia which may include a negotiable instrument such as check, coupon or the like or alternatively, the indicia may include response or interest surveys, membership cards or similar mailings intended to extract some sort of indication of interest by the recipient. The address is printed on the face of the mailer intermediate and upon folding of the intermediate about a fold line, the address is visible through a window cutout.

### CROSS-REFERENCES TO RELATED APPLICATIONS

None.

### FIELD OF THE INVENTION

The present invention relates generally to business and marketing communications. More particularly, the present invention pertains to a windowed mailer postcard intermediate that has a pair of similarly sized, substantially quadrate panels, that when folded about a central fold line, form a postcard suitable for use with the mail. The instant invention can be used for a number of applications in which the sender provides the recipient with the ability to communicate with the product or mailing campaign sponsor such as through the redemption of a product coupon, rebate check or utilization of a service offering, such as those provided through the use of membership cards, identification cards and the like.

### BACKGROUND OF THE INVENTION

The use of postcards is generally attractive in that postcards can deliver information to intended recipients by taking advantage of reduced postal rates. Postcards have been used in the past and are regularly used to convey billing information to recipients such as utility, refuse collection or other contracted services to the homeowner or business. Postcards have also served to deliver notice to recipients about the availability of an order, reminder of appointments and the like. One exemplary postcard construction is provided in U.S. Pat. No. 2,018,984. However, such postcards suffer from a principal drawback in that they do not conceal any information from those that come into contact with the cards.

The availability of personal information is particularly worrisome with respect to scheduling medical and dental appointments, where recent legislation requires the information related to a patient to be protected thus preserving the confidentiality of the patient. Moreover, recipients of postcards used for utility bills or other services, may simply not want information about their accounts to be exposed. Such account information can potentially be used to tap into credit and other personal information by unscrupulous individuals. In addition, where the postcard announces the arrival of goods that have been ordered, the recipient may not want that information to be made available in such an easily discernable manner so as to avoid unwanted attention.

Postcards or double postcards, which in effect create a laminated construction have been used in the past to mail or issue refund checks, such as show in U.S. Pat. Nos. 5,667,134 and 5,924,737. The foregoing prior art constructions however require duplex printing, that is printing on both sides of the substrate so as to create a complete construction that is suitable for passage through the postal system. Those individuals without the ability to process such constructions in a duplex manner thus cannot take advantage of postcards for mailing information. Even where the capability exists, companies may not want to take advantage of the postal savings as the additional production time required with duplex printing may offset any savings that the user may realize.

Thus, what is needed is a postcard intermediate that provides the user with the ability to process postcard mailers with simplex printing, imaging only provided on one side of the substrate. Such a product would not only cut the processing time to produce the mailer intermediate in half (only one pass is required through a printer), but perhaps more importantly, the ability to simplex print the substrate would expose the postcard as a communication piece to a significant larger audience, including the small office or home office or “SOHO” applications.

Publications, patents and patent applications are referred to throughout this disclosure. All references cited herein are hereby incorporated by reference.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly, it has been found that the use of postcards for conveying information to intended recipients has been largely limited in that prior art constructions required duplex printing which requires the card to be printed on both sides in order to effectuate the mailing of the communication piece. In addition, cards heretofore have not been utilized as a vehicle to forward cards, coupons and other opportunities that may be of interest to end users, including response, survey and requests for information.

In one embodiment of the present invention, a windowed mailer postcard intermediate, is described and includes a substantially quadrate sheet of material having a first face and a second face, first and second longitudinally extending sides and first and second transversely extending end edges. The sheet is divided into first and second substantially quadrate sections by a fold line extending substantially medially of the sheet and running parallel to the end edges, with each of the first and second sections having top and bottom edges and first and second longitudinally extending sides. Each of the first and second sections having a central portion and an edge portion. One of the first and second sections of the presently described embodiment is provided with a window cutout that is positioned closer to one of the top and bottom edges and spaced inwardly from the edge and substantially within the central portion.

The above mentioned embodiment may be provided with address information on one of the panels opposite that of the window panel such that when the sections are folded about the fold line the address information is visible through the window. In an alternative arrangement, the address information may be provided on a removable label so that the entire section may be printed with information and then the label that is used for address information is removed prior to use of the section.

The window cutout may be covered with a glassine or other substantially transparent patch so as to fully cover the cut out and protect the information underlying the cutout area.

In a still further embodiment of the present invention, a windowed postcard for mailing negotiable instruments is provided and includes a substantially quadrate sheet of material capable of receiving printing. The sheet has first and second faces, first and second sides and first and second end edges and a fold line that divides the sheet into first and second panels. In this embodiment, each of the first and second panels have a line of weakness disposed inwardly from the end edge and which runs parallel to the edge so as to define a major and minor area of the panels. One of the minor areas contains postal indicia on one of the first and second faces and adhesive on the other of the minor areas the first and second panels.

In this presently described embodiment, a window cutout is also provided in the first panel and is sized and configured so as to be able to display address information when the first panel is folded over the second panel such that the cutout overlies the address information. The window cutout is disposed at least substantially in the major area of the first panel. The windowed postcard intermediate of this embodiment is suitable for the inclusion of a negotiable instrument which is provided on the second panel in the major area. The negotiable instrument is printed with indicia that enables redemption by a recipient.

In an alternative or supplemental arrangement, the windowed postcard mailer intermediate can be provided with a card, selected from a group including business cards, identification cards, membership cards, credit cards and combinations thereof as an economical means of delivering cards to the intended end user.

In a yet still further embodiment of the present invention, a method of using a windowed postcard, is described and includes the steps of initially providing a substantially quadrate sheet of material that has first and second faces and first and second panels and a windowed cutout provided in the first panel. The first and second panels each have major and minor areas. Next, address information is imprinted on a portion of second panel on the first face and substantially within the major area of the panel. After address information is printed then recipient interaction indicia is imaged on the second panel on the first face and substantially within the major area.

Continuing with a brief description of the presently described embodiment, once the printing and/or imaging is completed the sheet is then folded about a fold line such that the address information is visible through the window cutout to form an outgoing postcard mailer. Once the postcard mailer is folded and sealed it is then sent to a pre-determined recipient. The recipient then returns at least a portion of the panel with the recipient interaction indicia thereon and that portion is received by a clearing house or the like which processes the portion of the panel having the recipient interaction indicia such that the information can be recorded and reported to the sponsor or sender of the postcard mailer intermediate.

In a still further exemplary embodiment of the present invention a windowed postcard for mailing cards, is provided and includes a substantially quadrate sheet of material capable of receiving printing. The sheet has first and second faces, first and second sides and first and second end edges and a fold line that divides the sheet into first and second panels.

In this embodiment, each of the first and second panels have a line of weakness that is disposed inwardly from the end edge and runs parallel to the edge so as to define a major and minor area of the panels. One of the minor areas containing postal indicia on one of the first and second faces and adhesive on another of the minor areas of the first and second panels.

Still continuing with the presently described embodiment of the instant invention, a window cutout is provided in the first panel and is sized and configured so as to be able to display address information when the first panel is folded over the second panel such that the cutout overlies the address information. The window cutout is disposed at least substantially in the major area of the first panel. A card is provided in the current embodiment and is selected from a group including business cards, identification cards, membership cards, credit cards and combinations thereof. The card is positioned and placed on the second panel in the major area, with the card containing indicia enabling use by a recipient.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a front view of the windowed postcard intermediate of the present invention;

FIG. 2 illustrates the back face of the windowed postcard intermediate and provides a window patch and adhesive sealing patterns suitable for use in creating a sealed outgoing mailer;

FIG. 3 shows the postcard, windowed intermediate of the present invention illustrating the inclusion of a negotiable instrument and indicia related to the transmission and use of the instrument and using a removable label shown in phantom to carry address information;

FIG. 4 provides a side elevation of the present invention showing the window patch, removable label and in an alternate or supplemental embodiment a card;

FIG. 5 depicts the windowed postcard in a folded and sealed condition with address or delivery information visible through the window;

FIG. 6 illustrates an additional embodiment of the present invention and includes a removable card and coupon;

FIG. 7 shows a response return postcard that is provided in connection with coupons or other product or service offerings;

FIG. 8 provides a still further view of the present invention in which an identification card or the like is provided on the winnowed panel of the postcard mailer;

FIG. 9 depicts a modified version of the postcard mailer for transmitting checks to a recipient;

FIG. 10 illustrates a further embodiment of the present invention in which the negotiable instrument is contained on the windowed panel of the postcard mailer so that a return piece may be provided; and

FIG. 11 provides a block diagram showing the steps of using the windowed postcard mailer of the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

Unexpectedly, it has been found that by being able to use a simplex printable postcard mailer, by the inclusion of window cutout, the market of available opportunities as well as users expands exponentially, thereby making postcards a more effective communication piece.

Sheets suitable for forming the windowed postcard mailer intermediate of the present invention should have a size of about eight and a half inches by about five and half to about six inches (8.5″×5.5″-6″). When the material is folded about a fold line each panel or section will have dimensions of approximately 4.25″ by 5.5″-6.″

Material selected for use with the present invention should be printable and capable of being passed through postal sorting equipment. Generally, cellulosic stock is selected and the stock may contain a coating which adds a glossy appearance to the stock. Where cellulosic stock is selected normally a tag or card stock is used ranging from 80 to 120 pound material. Alternatively, one may use synthetic film for a base material. The material can be provided in a cut sheet arrangement or may be made available in a continuous format. In either format, the intermediates of the present invention are generally provided in a two wide or “two up” configuration. For an 8.5″ by 11″ sheet of material, the postcards will have dimensions of 8.5″ by 5.5″ to achieve the 11″ size of the sheet material.

If a negotiable instrument is provided, it should have a minimum dimension of approximately 6″ by 2¾″ so as to be able to be processed through a financial institution. Minor portions, as will be described herein, are typically removed prior to attempting to process such instruments and will have an equivalent length of about 6″ and a width ranging from ½″ to 1½″. The minor portion needs to be sufficient in size so as to be able to accommodate postal indicia such as FIM codes and other sorting codes or information as is necessary and understood by those with skill in the art.

In still other possible embodiments, the windowed mailer intermediate of the present invention can comprise two different materials such as cellulosic and synthetic that may be joined to one another along a mid point such as through the use of tape or other joining means. In this embodiment, where a sponsor of the mailing desires to provide a plastic or synthetic card, the card can be die cut from the synthetic material.

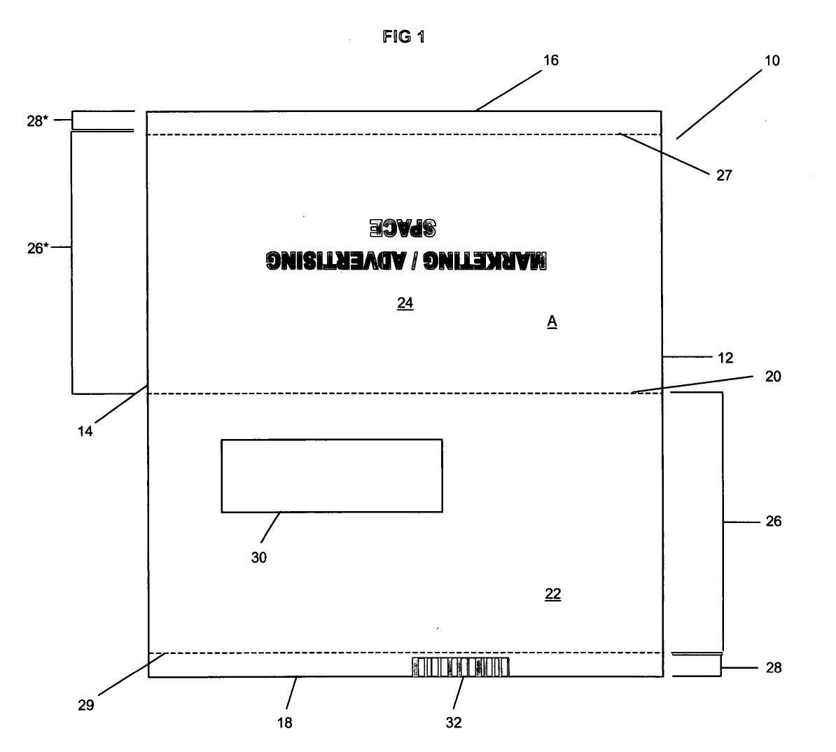

Turning now to the FIGURES provided along with the instant specification, FIG. 1 depicts one face of the windowed postcard intermediate of the present invention. The postcard intermediate is generally referred to herein by reference to numeral 10.

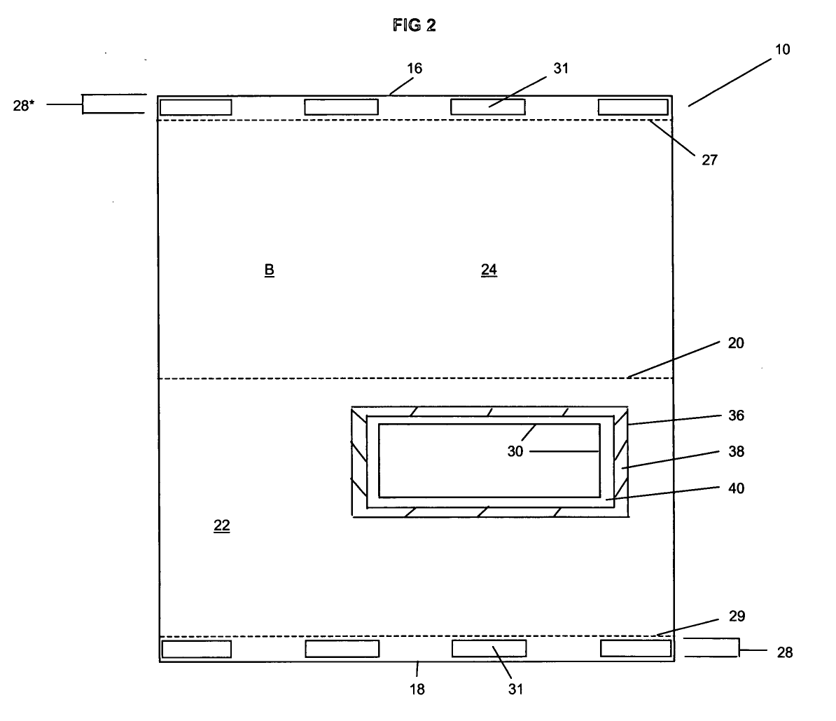

The postcard windowed intermediate mailer 10 has first and second sides referred to by the letters “A” and “B” with the second face being shown in FIG. 2. The intermediate 10 has first and second longitudinally extending sides 12 and 14 and first and second transversely extending end edges 16 and 18. The intermediate 10 is divided by a fold line 20 into first and second sections or panels 22 and 24. The fold line 20 may include a score line, line of weakness, perforation line or the like which would enable the first and second sections 22 and 24 to be separated from one another for the purposes of using the panels for the purpose intended. Each of the panels or sections 22 and 24 has first and second ends which are defined by transverse end edges 16 and 18 and the fold line 20. The sections or panels 22 and 24 have a major and minor portions or central and edge areas 26, 26* and 28, 28*, respectively.

A window cutout 30 is provided in panel or section 22 and is positioned inwardly of the edge defined by fold line 20 and substantially within the major portion or central area 26 of the intermediate 10 of the present invention.

The minor portion or edge area 28 and 28* of each of the panels or sections 22 and 24, is defined by a lines of weakness 27 and 29 (perforation lines) which enable the separation of the minor or edge portion from the remainder of the mailer intermediate 10. In this way, postal indicia 32 as well as adhesive patterns (discussed in FIG. 2) can be removed from the intermediate 10 thereby enabling the processing of the redemption piece such as a coupon, negotiable instrument or the transmission of a response card, survey or the like.

FIG. 1 also provides space for advertising or marketing messages 34. Such advertising or marketing information may be preprinted such as by the manufacturer of the card so that duplex printing is not required by the end user and the card can still be processed in a simplex fashion. Alternatively, the provider of the substrate can produce colors, trademarks and the like prior to providing the material to the end user or manufacturer that may further process the substrate or material such as by the die cutting of the material.

FIG. 2 shows the back or second face “B” of the mailer intermediate 10 of the present invention. As can be seen in FIG. 2, the minor or edge portions 28 and 28* have been provided with an adhesive 31 so that when the intermediate is folded about fold line 20 the intermediate will be sealed along edges 16 and 18.

As used herein, the term “adhesive” includes, but is not limited to strips, patterns, segments, shapes, spots, continuous arrangements, discontinuous arrangements and combinations thereof. The type of adhesive that may be used includes but is not limited to repositionable, removable, permanent, remoistenable, hot melt, pressure seal (cohesive), cold glues and combinations and mixtures thereof. The present invention may also include adhesive strips that are provided in the form of transfer tapes, pressure sensitive tapes and the like which usually will have a removable release liner, which when removed will expose and/or activate the adhesive that can be used to form a sealing arrangement.

In the present invention, mating patterns of a cohesive 31, such as that described in U.S. Pat. No. 4,918,128 are used to create a pressure sealing type closure. That is, as the patterns are brought into contact with one another and pressure is applied, the mating patterns form a relatively permanent bond to secure the mailer intermediate 10 together along the end edges 16 and 18.

FIG. 2 also illustrates the use of a transparent patch 36 that has been provided over the window cutout 30. The patch 36 may be glassine or other material that is suitable for allowing address or other information to be visible. The patch 36 is secured through the use of an adhesive 38 (typically a permanent, acrylic based adhesive). As is illustrated, the adhesive remains clear of the cutout window 30 creating an adhesive free zone 40 which precludes the adhesive from oozing into the area of the cutout 30 which may cause the panels or sections 22 and 24 to adhere unintentionally together.

It should be pointed out at this juncture that in order to qualify for reduced postal rates, the interior of the assembly must open such as by bowing the panels 22 and 24 of the assembly outward (away from one another) so that an ovoid shape is created. Thus, adhesive from the patch needs to remain out of contact with the surface of panels 22 and 24, hence the preference for an adhesive free zone 40 as provided in FIG. 2 of the instant specification. Exemplary patches used in the present invention are available from Ward/Kraft, Inc., of Fort Scott, Kans. and are sold under the name VIEWTECH™.

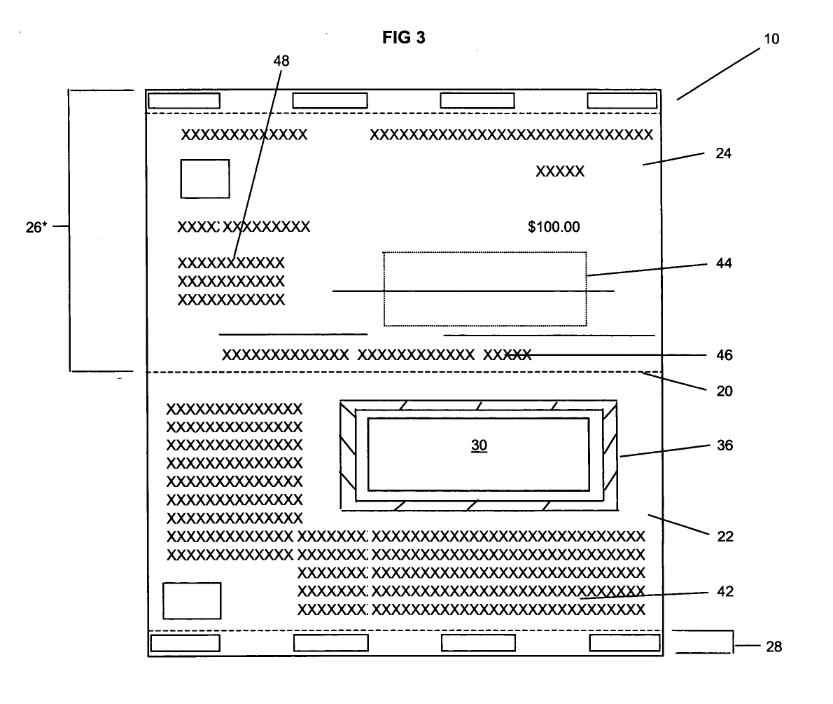

FIG. 3 of the present invention illustrates one exemplary use of the postcard intermediate 10. Panel 22, containing the cutout window 30 covered by transparent patch 36 is also provided with supplemental use indicia 42. This information may include data related to why the recipient is receiving the mailing as well as directions for use. In addition, the indicia 42 may contain other marketing or advertising messages which may or may not be personalized to the particular recipient.

The second panel 24 is imaged with a negotiable instrument such as a check in the major or central portion 26 of panel 24. The negotiable instrument would include MICR numbering 46 would contains information relating to the account and routing number of the payor bank for the purposes of processing the instrument.

FIG. 3 also illustrates the use of a removable label 44, shown in phantom on the panel 24. The removable label would be used to carry address information that would be visible when the window cutout is positioned over the label. The label would likely contain a light tack adhesive such as a repositionable adhesive, such as POST-IT® type adhesive available from 3M of St. Paul, Minn. so that the label could be easily removed from the instrument prior to the instrument being utilized by the recipient. The label 44 would be provided or placed onto the panel 24 after the intermediate has been imaged and may be placed by hand, such as may occur in a SOHO environment or alternatively may be blown or tipped on by means readily known or utilized in the industry.

Other indicia 48 is typically added to the panel 24 prior to the mailing. In the example of a negotiable instrument, this may include the recipient's name, amount in numerical and alpha characters, address information, company and the like.

If a removable label 44 is not used to provide the address information, then the window would be located in an area adjacent to the minor area or portion 28 and may partially overlap the minor portion 28 so that a full size check or negotiable instrument may be provided.

The indicia on panels 22 and 24 may be printed all in one direction or one panel may have indicia provided that has an upside down appearance when viewed from the same end edge or angle. Printing of the indicia is accomplished by any known means such as non-impact printers, laser, ink jet, ion deposition and the like.

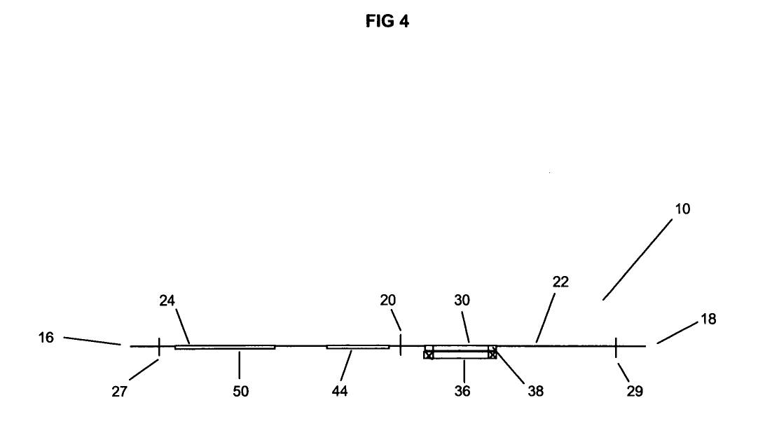

Attention is now directed to FIG. 4 of the instant invention where the intermediate 10 is shown from a side perspective. The intermediate 10 is again shown with first and second sections 22 and 24, having end edges 16 and 18. Fold line 20 separates the panels 22 and 24 from one another and forms generally quadrate sections as shown in the previous FIGURES.

FIG. 4 also provides lines of weakness 27 and 29 that show the separation of the major and minor portions of the sections of the panels. Window cutout 30 is shown to illustrate the adhesive layer 38 and transparent patch 36 over the cutout area 30. In addition, as shown in FIG. 3, a removable label 44 is shown as is a card, coupon or the like 50 which will be discussed in connection with additional FIGURES herein.

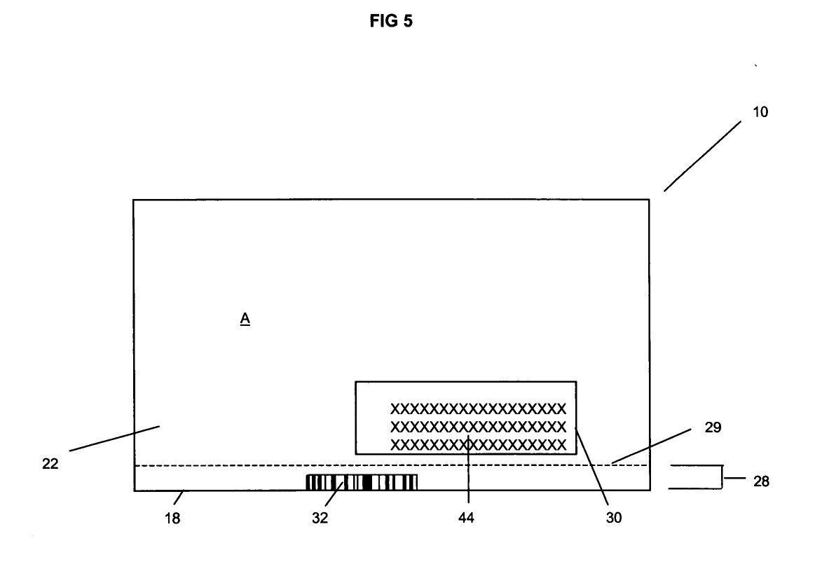

Turning now to FIG. 5 shows the intermediate 10 in a folded condition. Panel 22 and face “A” are shown in the FIGURE as is window cutout 30 having address indicia 44 shown therein. FIG. 5 illustrates a different position of the window cutout 30 than those illustrated in the earlier FIGURES. Here, the cutout is disposed adjacent the minor portion 28 that is defined by line of weakness 29 and end edge 18. The address indicia 44 can be provided via a label or alternatively can be printed directly on face “B” of the substrate 10, panel 24. In this configuration sufficient space is provided so that a fully negotiable check can be delivered to the recipient.

Postal indicia 32 such as a FIM code is provided in the minor or edge portion area 28 and is to be detached via the line of perforation 29 so that the postcard mailer may be opened by the recipient. Tearing the intermediate 10 along line 29 will also remove the adhesive patterns that are used to seal the intermediate 10.

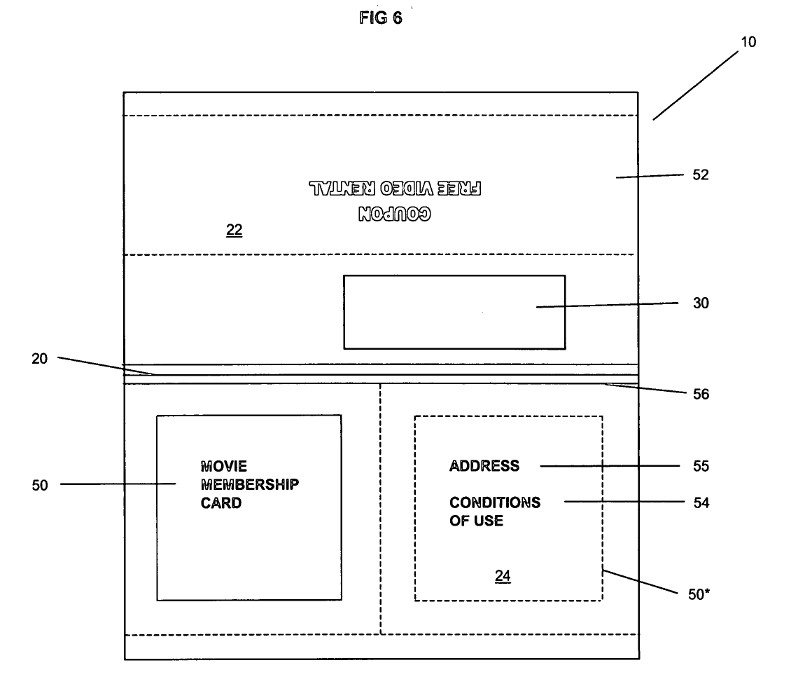

FIG. 6 depicts a still further embodiment of the present invention. The intermediate postcard mailer 10 is provided with a card 50 which may be a membership card, business card, identification card, credit card or the like. The card 50, is provided on panel 24 and on interior face “B” of the intermediate 10. The card 50 may be blown or tipped on to the surface 24 of the intermediate 10 and secured to the surface or face “B” through a removable adhesive.

In addition to the card 50 in the present embodiment, a coupon 52 may also be provided as part of the offering. For example if card 50 is membership card to a video store, then coupon 52 can be a matched or complementary piece such as a coupon for a free movie rental or the like. Conditions for use, membership information and the like may be printed at 54 and the address to whom the card 50 and coupon are to be delivered is imaged at 55 which will be visible through the window 50 when the intermediate 10 is folded about fold line 20.

In an alternate embodiment, for the intermediate 10, panels 22 and 24 may be composed of different materials. For example panel 22 which contains the window cutout 30 and coupon 52 may be prepared from a cellulosic stock, whereas panel 24 which includes the membership card 50 may be composed of a synthetic material such as plastic. The two different materials are then joined to one another through a strip of tape 56 or the like. The tape 56 would then have the line of perforations extending there through so that sections 22 and 24 could be separated from one another along fold line 20.

In this example, instead of tipping or blowing the card 50 onto the section 24, the card 50 is formed integrally with the panel by die cutting the area to be occupied by the card as will be readily understood by those skilled in the art. Thus, when the mailer intermediate 10 is received by the recipient instead of peeling the card 50 up from the adhesive, the card 50 is punched out of the material.

While the card of the embodiment of FIG. 6 is shown in a “portrait” configuration, the long dimension extending parallel to the longitudinal sides of the postcard, the card 50 may be presented in “landscape” mode in which the long dimension extends perpendicularly to the long dimension of the postcard intermediate 10.

In a still further embodiment of the present FIG. 6, a second card 50* is shown in phantom so that plural cards could be provided to a single address, such as may be used by a family. Either a removable label would be used to provide the relevant address information or alternatively, the address information would be printed on a portion of the membership card 50*. In this embodiment, the conditions of use 54 may then be provided on panel 22 and the coupon 52 may or may not be provided or it may be provided in a different configuration such as adjacent the window cutout 30.

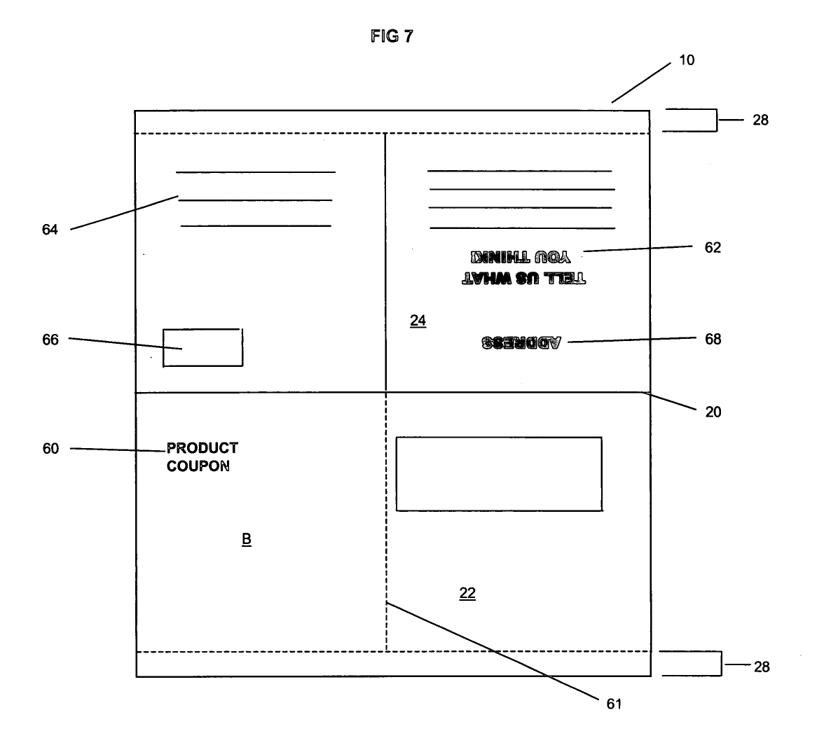

Reference is now directed to FIG. 7 of the present invention in which the intermediate 10 is depicted in a response configuration. As provided previously, the intermediate 10 is simplex printed so that face B contains all the printing to be provided relating to the offering to be sent by the sponsor of the mailing. Panel 22 may contain a coupon 60 related to a product or service offering that the sponsor of the mailing wishes the recipient of the intermediate 10 to try. Coupon 60 may be separated from the window portion of the panel along line of weakness 61.

After the product or service is sampled by the recipient of the intermediate 10, the recipient would complete the survey or response section 64 contained on panel 24 and then simply forward the panel 24 to the pre-printed address 64 provided on panel 24. The panel 24 would be provided with postage 66 and would contain the address information from whom the response is being mailed. Panel 24 is separated from panel or section 22 along fold line 20 as has been previously described. In this way, the sponsor of the mailing has information related to those respondents to send out future mailings. Prior art postcards would typically not contain this information.

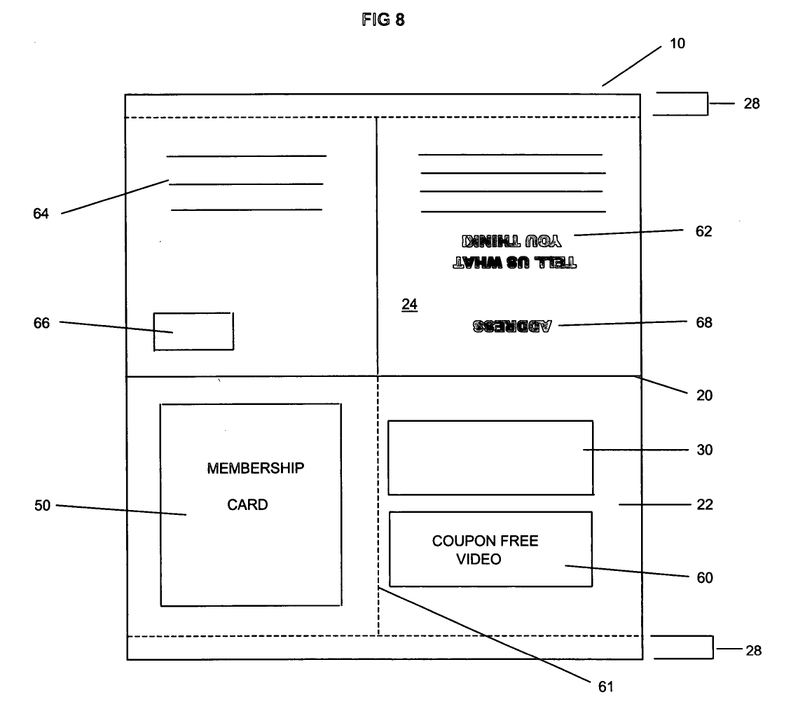

Turning now to FIG. 8, where a further embodiment of the present invention is presented and provides for the inclusion of a membership or identification card 50 on the windowed panel 22. In addition, the remainder of the panel 22 may be used for the provision of a coupon 60 or the like. As previously discussed, the ends 28 are sealed to one another and the address 68 printed on panel 24 is visible through the window 30. In this embodiment, the card 50 can be removed and a response provided by the return postcard constructed from panel 24.

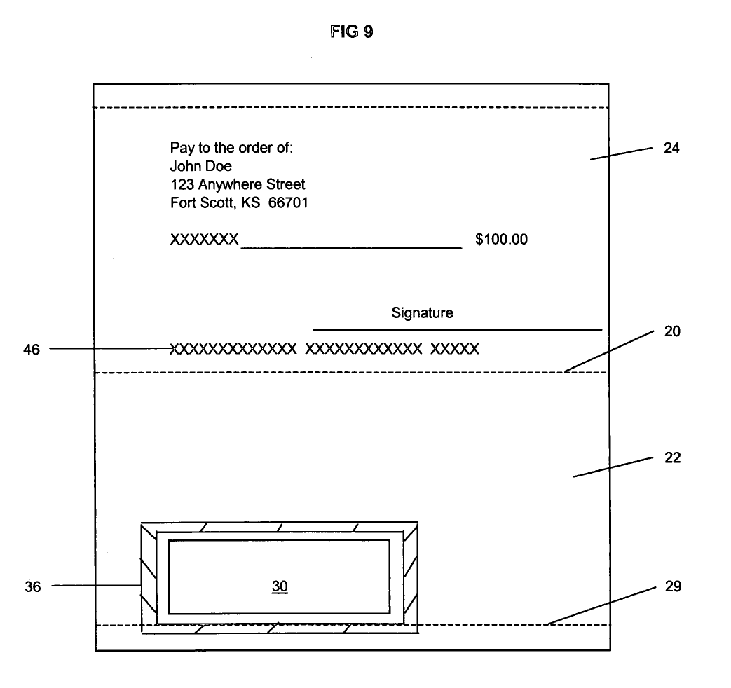

FIG. 9 provides a further modification of the embodiment provided in FIG. 3. In FIG. 9, indicia relating to a check, such as MICR numbering 46, are printed on panel 24. Instead of using the label 44 of FIG. 3 to show the address, instead the window 30 is positioned near the end edge of the postcard mailer so that when the postcard mailer is folded about line 20, the address information will be visible through the window. As can be seen in this FIGURE, the window is provided over perforation line 29 and the window patch 36 is itself perforated enabling the postcard construction to be opened.

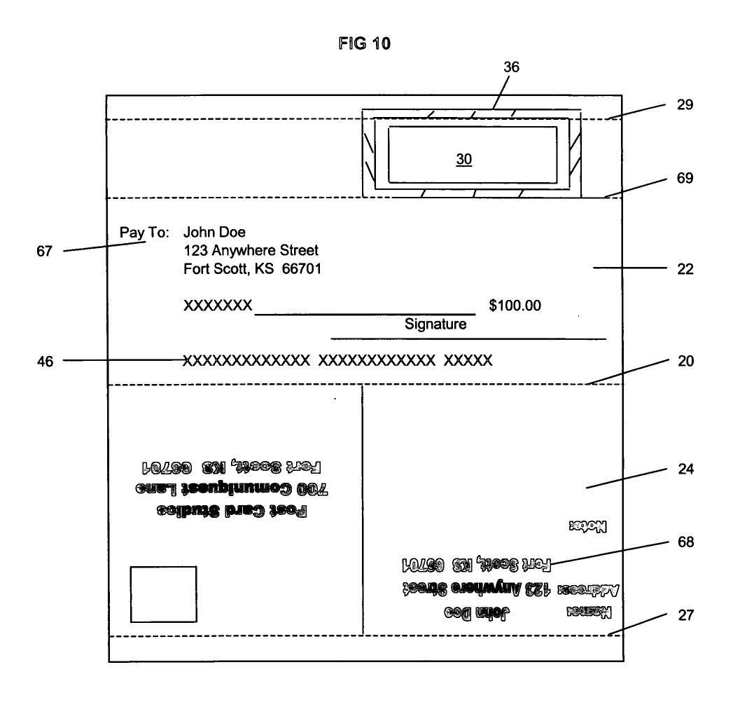

Attention is now directed to FIG. 10 of the present invention, in which a further embodiment of the postcard mailer is provided. In this arrangement, a negotiable instrument is provided on the windowed panel 22. The negotiable instrument is provided with MICR printing 46 and other information related to the payor and payee 67 such as the amount and the like. The address information 68 will be visible through the window 30 when the postcard mailer is folded about central fold line 20. In this embodiment, the address information or payor information 67 is reverse image printed to the address information 68 which will appear through the window. The postcard mailer will still be opened by tearing along perforation lines 27 and 29. Perforation line 29 in this embodiment will also be provided such that the material 36 covering the window 30 will also be perforated so that the mailer may then be opened.

In order to process the negotiable instrument, the check will have to be detached from the window portion along perforation line 69 as well as from panel 24 along medial fold line 20. The instrument is then endorsed by the recipient and processed through conventional means.

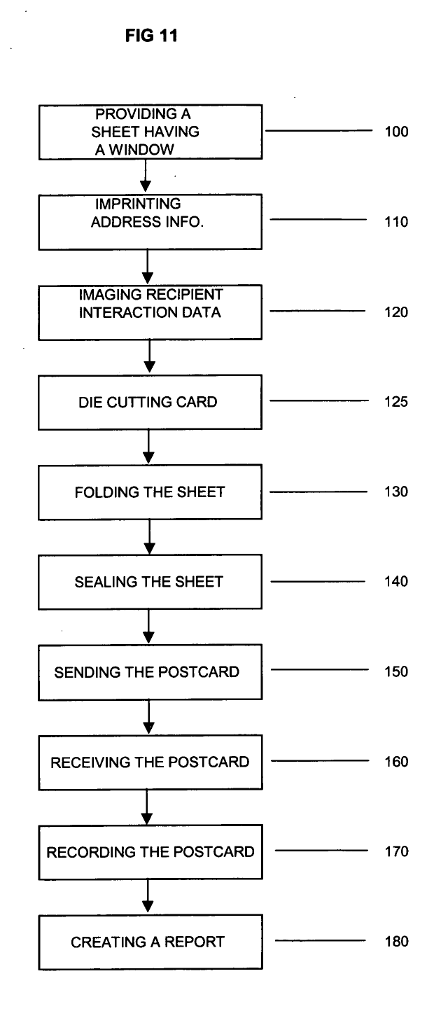

FIG. 11 presents a block diagram relating to a proposed method of using the postcard intermediate of the present invention. At the first step 100, a substrate is provided. The substrate may be constructed of a single type of material or may represent a combination of material types that may be joined together such as by a line or strip of tape or the like. Next, the substrate or sheet of material which is intended to be generally planar so as to be able to easily process through a printer is imprinted at step 110 with address information of the intended recipient. The imprinting of address information may also include the printing of postal indicia. Alternatively, postal indicia can be provided by a manufacturer of the product. At step 120 recipient interactive data is provided on the surface of the intermediate.

The term “recipient interactive” data or indicia is intended to mean indicia that enables a recipient the ability to act or interact with the mailing, such as through the processing of a negotiable instrument, i.e. the cashing of a check, use of a coupon such as through a bar code, personalized information that elicits a response or action from the recipient and such other information, data or indicia that will generally provide a stimulus to the recipient to take some action or steps in furtherance of the mailing.

It should be understood that the steps of applying the address information and interactive indicia may be provided in reverse order, that is the interactive data is printed first and then the address information printed second.

Once the indicia has been provided, and if a card or plural cards are to be provided, the cards would then be die cut at step 125 to create the necessary cuts to enable a recipient with the ability to remove the card from the intermediate. After the application of the indicia, the substrate is then folded at step 130 about a centrally disposed fold line as has been discussed previously.

Next, and still referring to FIG. 11, the mailer postcard is sealed at step 140 using adhesive, which may seal immediately on contact such as with a pressure sensitive adhesive or alternatively through the use of an adhesive that requires some subsequent treatment such as heat, moisture or pressure to affect the sealing of the intermediate.

After the postcard has been folded and sealed at steps 140 and 150, the postcard is then placed in the mail at step 150. It should be understood that placing the postcard in the mail may also comprise placing the postcard with a courier or other delivery service. The intention of step 150 is that the postcard will ultimately be received by the recipient at step 160. It is hoped that through the delivery of the postcard and the presentation of recipient interactive data that the mailing will be responded to at step 170. If the recipient responds to the mailing, then the sponsor can collect response data at 180 so as to determine whether the mailing was successful or not. Alternatively, the sponsor of the mailing can contract with a third party to collect the postcards and deliver a report to the sponsor of the mailing. Response collection can be conducted at the same site as the mailing or at different or remote sites from one another.

It will thus be seen according to the present invention a highly advantageous windowed mailer postcard intermediate has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A windowed mailer postcard intermediate, comprising
a substantially quadrate sheet of material having a first face and a second face, first and second longitudinally extending sides and first and second transversely extending end edges;
said sheet is divided into first and second substantially quadrate sections by a fold line extending substantially medially of said sheet and substantially parallel to said end edges, each of said first and second sections having top and bottom edges and first and second longitudinally extending sides and each of said first and second sections having a central portion and an edge portion; and
one of said first and second sections is provided with a window cutout that is positioned closer to one of said top and bottom edges and spaced inwardly from said one of said edges.

2. A windowed mailer postcard intermediate as recited in claim 1, wherein at least one of said first and second sections is provided with a line of weakness extending substantially parallel to said bottom edge and spaced inwardly therefrom and running perpendicularly to said longitudinally extending sides.

3. A windowed mailer postcard intermediate as recited in claim 1, wherein each of said first and second sections is provided with a line of weakness extending substantially parallel to said bottom edge and spaced inwardly therefrom and running perpendicularly to said longitudinally extending sides.

4. A windowed mailer postcard intermediate as recited in claim 1, wherein one of said first and second faces receives indicia.

5. A windowed mailer postcard intermediate as recited in claim 1, wherein address information is printed on one of said first and second sections such that when said first and second sections are folded about said fold line, said address information is visible through said window.

6. A windowed mailer postcard intermediate as recited in claim 1, wherein said window cutout is provided with a glassine patch that covers said window cutout.

7. A windowed mailer postcard intermediate as recited in claim 1, wherein an adhesive pattern is provided along at least one of the bottom edges of said first and second sections.

8. A windowed mailer postcard intermediate as recited in claim 7, wherein said adhesive pattern is provided along each of said bottom edges of said first and second sections.

9. A windowed mailer postcard intermediate as recited in claim 8, wherein said adhesive pattern is mating cohesive pattern that forms a bond upon application of pressure to seal the patterns to one another.

10. A windowed mailer postcard intermediate as recited in claim 5, wherein said address information is provided on a removable label applied to said one of said first and second sections and positioned such that said label is visible through said window cut out upon folding said first and second sections about said fold line.

11. A windowed mailer postcard intermediate as recited in claim 1, wherein said fold line is a line of perforation enabling said first and second sections to be separated from one another along said fold line.

12. A windowed mailer postcard intermediate as recited in claim 1, wherein one of said first and second sections is provided with a card selected from a group including business cards, identification cards, membership cards, credit cards and combinations thereof.

13. A windowed postcard for mailing negotiable instruments, comprising;
a substantially quadrate sheet of material capable of receiving printing, said sheet having first and second faces, first and second sides and first and second end edges and said sheet having a fold line dividing said sheet into first and second panels;
each of said first and second panels having a line of weakness disposed inwardly from said end edge and running parallel to said edge so as to define a major and minor area of said panels and one of said minor areas containing postal indicia on one of said first and second faces and adhesive on another of said minor areas of said first and second panels;
a window cutout is provided in said first panel and is sized and configured so as to be able to display address information when said first panel is folded over said second panel such that said cutout overlies said address information, said window cutout is disposed at least substantially in said major area of said first panel; and
a negotiable instrument provided on one of said first and second panels in said major area, said negotiable instrument containing indicia enabling redemption by a recipient.

14. A windowed postcard for mailing negotiable instruments as recited in claim 13, wherein a removable label is provided on said second panel and is disposed in said major area of said second panel and contains address information viewable through said window cutout when said first and second panels are folded about a fold line.

15. A windowed postcard for mailing negotiable instruments as recited in claim 13, wherein said indicia is MICR encoding.

16. A windowed postcard for mailing negotiable instruments as recited in claim 13, wherein said indicia is a barcode.

17. A windowed postcard for mailing negotiable instruments as recited in claim 13, wherein said adhesive is provided in a pattern.

18. A windowed postcard for mailing negotiable instruments as recited in claim 13, wherein one of said first and second panels is provided with a card selected from a group including business cards, identification cards, membership cards, credit cards and combinations thereof.

19. A method of using a windowed postcard, comprising the steps of;
providing a substantially quadrate sheet of material having first and second faces and first and second panels and a windowed cutout provided in said first panel, said first and second panels having major and minor areas;
imprinting address information on a portion of said second panel on said first face substantially within said major area;
imaging recipient interaction indicia on said second panel on said first face substantially within said major area;
folding said sheet about a fold line such that said address information is visible through said window cutout to form an outgoing postcard mailer;
sending said postcard mailer to a pre-determined recipient;
receiving at least a portion of said panel with said recipient interaction indicia; and
recording said recipient interaction indicia.

20. A method of using a windowed postcard as recited in claim 19, wherein said recipient interaction indicia is selected from a group including checks, coupons, surveys, expressions of interests, response cards and combinations thereof.

21. A method of using a windowed postcard as recited in claim 19, including a further step of applying a removable label to said second panel to receive address information prior to the step of imaging address information.

22. A method of using a windowed postcard as recited in claim 19, wherein the step of recording said recipient interaction indicia includes redemption.

23. A method of using a windowed postcard as recited in claim 19, wherein the second face is provided with advertising or marketing indicia.

24. A method of using a windowed postcard as recited in claim 19, wherein the step of imaging the recipient interaction data occurs prior to the step of imprinting the address information.

25. A method of using a windowed postcard as recited in claim 19, including a further step creating a report based on the recording of the recipient interaction data after the step of recording.

26. A method of using a windowed postcard as recited in claim 19, including a further step of placing a card on one of said first and second panels.

27. A method of using a windowed postcard as recited in claim 19, including a further step of sealing the panels to one another after the step of folding the sheet material.

28. A windowed postcard for mailing cards, comprising;
a substantially quadrate sheet of material of at least a first material capable of receiving printing, said sheet having first and second faces, first and second sides and first and second end edges and said sheet having a fold line dividing said sheet into first and second panels;
each of said first and second panels having a line of weakness disposed inwardly from said end edge and running parallel to said edge so as to define a major and minor area of said panels and one of said minor areas containing postal indicia on one of said first and second faces and adhesive on another of said minor areas of said first and second panels;
a window cutout is provided in said first panel and is sized and configured so as to be able to display address information when said first panel is folded over said second panel such that said cutout overlies said address information, said window cutout is disposed at least substantially in said major area of said first panel; and
a card selected from a group including business cards, identification cards, membership cards, credit cards and combinations thereof provided on at least one of said first and second panels in said major area, said card containing indicia enabling use by a recipient.

29. A windowed postcard for mailing cards as recited in claim 28, wherein the first and second panels are formed from first and second materials distinct from one another and joined together along said fold line.

30. A windowed postcard for mailing cards as recited in claim 29, wherein the first material is cellulosic and the second material is synthetic.
